(19) United States
(12) Patent Application Publication
(10) Pub. No.: US 2021/0372638 A1
(43) Pub. Date: Dec. 2, 2021

(54) THERMO ELECTRIC HEATING ASSEMBLY/ELEMENT FOR FORCED AIR RESIDENTIAL AND COMMERCIAL AIR-CONDITIONING AND FURNACES, POWERED BY CVD GENERATED 3D CNT GRAPHENE FILM

(71) Applicants: Gilbert Basaldua, Hilton Head, SC (US); Leslie S. Alton, JR., Rincon, GA (US)

(72) Inventors: Gilbert Basaldua, Hilton Head, SC (US); Leslie S. Alton, JR., Rincon, GA (US)

(21) Appl. No.: 16/886,863

(22) Filed: May 29, 2020

(51) Int. Cl. F24F 5/00; F24F 13/20; F24F 11/88; C01B 32/186

(52) U.S. Cl. CPC F24F 5/0042; F24F 13/20; F24F 11/88; C01B 32/186; F24F 2140/60; C01B 2204/22; C01B 2204/32; C01P 2004/13; C01P 2004/30; F24F 2221/34

(57) ABSTRACT

A thermo-electric heating assembly for forced air, residential and commercial heating, ventilation and air conditioning (HVAC) systems includes a housing, a controller and a plurality of carbon nanotube (CNT) heating elements, arranged in the housing. The controller is adapted to respond to a signal received by the controller indicating a need for heat by powering the carbon nanotube (CNT) heating elements at a controlled electrical power level for a controlled period, commensurate with the indicated need for heat. The CNT heating elements include upper and lower metallic radiator, at least two composite containment vessel and at least two 3D CNT graphene films. The CNT heating elements preferably include a third composite containment vessel and a layer of MgSO₄ or MgO.

### BACKGROUND OF THE INVENTION

The invention relates broadly to forced air heating, ventilation and air conditioning (HVAC) systems, and more particularly relates to an air to air heating system and method that rely upon carbon nano tubes (CNTs), manufactured through chemical vapor deposition (CVD) process, and preferably including MgSO₄ or MgO, to generate heat in lieu of conventional resistance heater coils, resulting in and efficiency increase of 2.6 to 3.4 times that of conventional HVAC systems, which rely on conventional heater coils.

Many HVAC systems include a heat pump. Simply, a heat pump uses a refrigeration cycle to move heat energy from a first environment to a second environment. The device is called a “heat pump” because the temperature of the first environment is lower than the temperature of the second environment, and so the natural direction of heat transfer would be from the second environment to the first environment. The heat pump reverses this natural flow of heat by “pumping the heat energy from a colder, first environment to a warmer, second environment. As long as there is at least some energy in the first environment, and an appropriate heat transfer fluid is selected, it is possible to transfer heat against the natural direction of heat transfer.

The advantage of using a heat pump is that it allows a heating system to rely upon and consume less energy from an external energy source to perform the heat transfer process than would be used to directly heat the first environment. For example, if electricity is used to operate a heat pump to heat a first space, and the alternative is to heat the space with an efficient electrical heater, then the heating system comprising the heat pump will typically consume less energy to directly heat the space than with a conventional heating system using a conventional electrical heater. A heat pump can be an attractive source of heating and cooling an indoor environmental space where the outdoor temperature does not reach extreme lows in the winter, and where the cost of electrical energy (used to operate a compressor and a fan in the heat pump) is not too high. For that matter, when the cost of electricity becomes very high, then heating with natural gas may be a more economical alternative. However, where natural gas is not available (for example, in a rural or a remote setting), then a heat pump is an attractive source of environmental heating and cooling even where the cost of electricity is relatively high.

Heat pumps are typically configured to operate in one of two modes: a summer mode and a winter mode. (These modes are alternately, and respectively, known as “cooling mode” and “heating mode”.) In the winter mode, the heat pump moves energy from a source of energy to an indoor environment, such as a residence or a commercial building. In the summer mode, the heat pump moves energy from the indoor environment to another location. Many heat pumps are configured to be able to switch from one mode to the other. Thus, the heat pump can act to heat an indoor environment in the winter and cool the same indoor environment in the summer.

Known sources of energy that can be accessed by the heat pump for winter mode include solar heat, ground or earth heat, ambient air, water (such as a river), and waste heat. Waste heat is more common in an industrial environment where heat from commercial processes (such as incineration) can be accessed. If the heat pump is to be used in the summer mode, then the objective becomes locating a destination to which heat from the indoor environment can be transferred. Obviously, for winter mode it is preferable to locate a source of energy having a large amount of available energy, such as solar energy. For summer mode, it is preferable to identify a location to which the indoor heat can be pumped which is relatively cool and will thus accept a large amount of heat. If the heat pump is configured to switch between modes, then it is preferable to locate a source that can provide heat for the winter mode yet accept heat in the summer mode. The most common source is to use the outside ambient (or atmospheric) air. In this case, the heat pump is known as an air-to-air heat pump since it moves heat between the air in the indoor environment and the air in the outdoor atmosphere.

U.S. Pat. No. 6,615,602 to Wilkinson, for example, discloses a heat pump with supplemental heat source. The heat pump includes a compressor, indoor heat exchanger, outdoor heat exchanger, outdoor thermal expansion valve and an auxiliary heat exchanger. An auxiliary fluid line and an auxiliary fluid pump circulate an auxiliary heat transfer fluid through the auxiliary fluid line, where the auxiliary heat exchanger exchanges heat between the refrigerant fluid and the auxiliary heat transfer fluid. The auxiliary fluid line is in thermal energy communication with a primary source of auxiliary heat. Preferably, the primary source of auxiliary heat is a fluid contained within a septic tank or like fluid storage space or volume available.

Also known are carbon nanotubes (CNTs). Carbon nanotube (CNT) are tubular structure made of carbon atoms, having diameter of nanometer order but length in micrometers. CNTs are many-fold stronger than steel, harder than diamond, display electrical conductivity higher than copper, and thermal conductivity higher than diamond, etc. CNTs have been found to possess a number of extraordinary properties, offering new capabilities and performance beyond the possibilities of heretofore known materials. For technological applications, especially in electronics, the prospects of carbon nanotubes are further enhanced by excellent thermal properties.

CNTs are stable at up to 2800° C. in vacuum and 750° C. in air, comparable to the 600° C. to 1,000° C. melting range of metal wires in microchips. More impressively, CNTs also display some of the best thermal conductivity. Single-walled carbon nanotubes exhibit a heat-transmission rate ranging from 1750 to 5800 W·m-1·K-1, and multiwalled carbon nanotubes show a rate of 3000 W·m-1·K-1. This is similar to, or better than, the best quality diamond's heat transfer rate of 3320 W·m-1·K-1, and up to a factor of 15 higher than the 385 W·m-1·K-1 of copper, one of the better heat conductors commonly used in current electronics. Thus, carbon nanotubes could support much denser (i.e. faster) circuits than the present edge of microprocessor technology.

Chemical vapor deposition (CVD) is the most popular method of producing CNT's nowadays. In this process, thermal decomposition of a hydrocarbon vapor is achieved in the presence of a metal catalyst. Hence, it is also known as thermal CVD or catalytic CVD (to distinguish it from many other kinds of CVD used for various purposes). FIG. 1 herein shows a chemical vapor deposition arrangement 100 for producing CNTs. As shown, hydrocarbon gas is supplied from a storage container 102 to furnace 104. Catalyst is added 106 and temperature monitored and controlled 108, where the output is provided to bubbler 110, which outputs the CNTs.

Traditional heating products are known to be inefficient and costly to run, comparatively, and require a significant amount of time to radiate sufficient heat for the space heated thereby to reach the desired level of comfort. This is because traditional heating products heat via convection, which works by heating the air around you. But an addition of CNT sheets to commonly deployed carbon fiber composite structures increases conductivity by an order of magnitude, and a 3-5 time increase in stiffness over aluminum core along with outstanding near-zero coefficient of thermal expansion (CTE) performance—all with reduced weight and improved mechanical damping.

In addition, CNT heating elements offer a high-efficiency heating solution without the limitations of conventional materials which require elements to be heated to very high temperatures to allow effective heating at a distance. CNT heating elements are manufactured via chemical vapor deposition into the final product format, eliminating the need for binders or secondary processing steps. They are composed of bundled CNTs hundreds of microns thick and millimeters long. CNT heating elements utilize far infrared energy (FIR), which as a result, imparts warmth more quickly than heating elements formed without. FIG. 2 herein is a graph of spectral intensity over wavelength for CNT heaters. The figure reflects that CNT heating products emit far infrared (FIR) energy in the wavelength of 3-10 microns, within which water is heated most efficiently. Moreover, because human skin is nearly 70% water, CNT heating provides a soothing heat that is readily absorbed by the body's thermoreceptors.

### SUMMARY OF THE INVENTION

The present invention overcomes the shortcomings of the prior art.

In an embodiment, the invention provides a thermo-electric heating assembly for forced air, residential and commercial heating, ventilation and air conditioning (HVAC) systems. The heating assembly comprises a housing, a controller and a plurality of carbon nanotube (CNT) heating elements, arranged in the housing. The controller is adapted to respond to a signal received by the controller indicating a need for heat by powering the carbon nanotube (CNT) heating elements at a controlled electrical power level for a controlled period, commensurate with the indicated need for heat.

Each of the plurality of CNT heating elements comprises: an upper metallic heat dispersion vein/radiator; a first composite containment vessel; a first layer of 3D CNT graphene film consisting of 2 separate strips of 3D CNT graphene films; a second composite containment vessel; and a lower metallic heat dispersing vein/radiator. The CNT heating elements may further comprise a third composite containment vessel and a layer of MgSO4 or MgO is arranged between the third composite containment vessel and the lower metallic heat dispersing vein/radiator. Preferably, the first and second composite containment vessels are formed from high-temperature resistant, electrically non-conductive, and highly heat conductive prepregs.

In an embodiment, the invention provides a kit for replacing a heating assembly positioned in a plenum, or proximate a plenum, of a forced air, residential and commercial heating, ventilation and air conditioning (HVAC) system. The kit comprises a thermo-electric heating assembly and wires, connected at one end to the thermo-electric heating assembly, for connecting at another end to a control panel of the HVAC system. The thermo-electric heating assembly comprises a housing, a controller and a plurality of carbon nanotube (CNT) heating elements, arranged in the housing. The controller is adapted to respond to a signal received by the controller indicating a need for heat by powering the carbon nanotube (CNT) heating elements at a controlled electrical power level for a controlled period, commensurate with the indicated need for heat.

The inventive thermo electric heating assemblies for forced air, residential and commercial HVAC systems furnaces, powered by CVD-derived carbon nanotubes (CNTs), may be included in new constructions, but is particularly suited to retrofitting into existing HVAC systems, replacing the heating coils therein. Replacing auxiliary electrical resistance heaters, known as “strip heaters,” with an inventive heating assembly with realize a drastic reduction in energy consumption, compared to 6 existing commonly used heating systems.

| Systems comprising | Compared Savings |
|---|---|
| (a) Geothermal Heat Pump | 43% |
| (b) Mini Split Heat Pump | 65% |
| (c) Standard Heat Pump | 72% |
| (d) Split AC and Furnace | 76% |
| (e) Boiler and AC | 79% |
| (f) Electric Furnace AC | 81% |

Essentially, the inventive heating assembly provides a very efficient way of production and is superior in design and economy as a producer of heat compared to nichrome/kanthal heater elements, natural/propane gas, conventional electrically powered metallic heating elements, Boiler and Geothermal Heat pump systems.

For that matter, because of the characterizes associated with CNT's, the inventive heating assemblies formed therewith are physically stronger and much more durable and reliable than current heating elements. This greatly increases service life and reduces maintenance. And the energy savings defines products created with the inventive heating assemblies green technology. CNT technology is environmentally friendly; no greenhouse gases are released in either their production or use, nor with their use produce significant carbon monoxide or carbon-fluoro-carbon gasses.

With the above and other objects in view, this invention consists of the combination and arrangement of parts more fully described and illustrated in the accompanying drawings and more particularly pointed out in the claims, it being understood that changes may be made in the form, size, proportions and minor details of construction without departing from the intent of the design or sacrificing any of the advantages of the invention.

### BRIEF DESCRIPTION OF THE DRAWINGS

The invention will be described in conjunction with the following drawings in which like reference numerals designate like elements and wherein:

FIG. 1 depicts a chemical vapor deposition arrangement for producing CNTs;

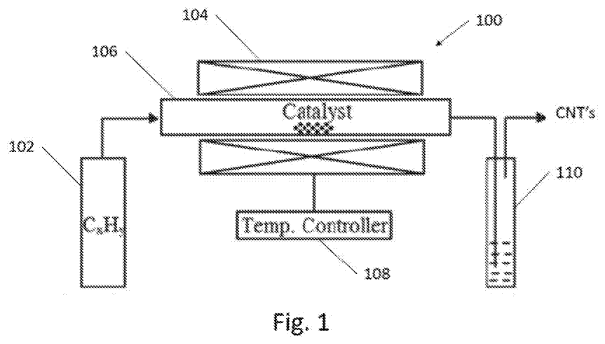

FIG. 2 depicts a graph of spectral intensity over wavelength for CNT heaters;

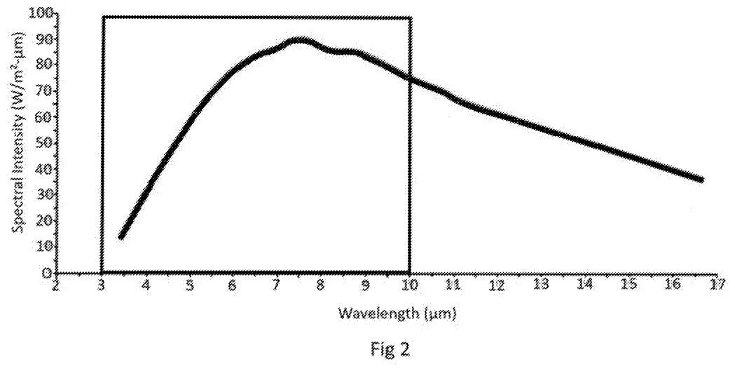

FIG. 3 depicts an isometric view of a conventional air-handler installed in a residence, modified to include the inventive CNT heating elements in an upper portion of the air-handler;

FIG. 4 depicts an enlarged isometric view of an inventive CNT heating assembly, constructed

FIG. 5 depicts an isometric view of the inventive CNT heating assembly configured with a sheet metal housing, omitted for clarity;

FIG. 6 depicts an enlarged isometric view of a front panel “A” of the inventive CNT heating assembly highlighting a wiring diagram for same;

FIG. 7 depicts an enlarged, exploded Isometric view of an embodiment of the inventive CNT heating assembly, highlighting an upper metallic heat dispersion vein/radiator, composite containment vessel, copper bus turnaround, positive and negative copper bus's, 3D CNT graphene film, copper wire connectors and lower heat dispersion vein/radiator;

FIG. 8 depicts a CNT heating assembly similar to that depicted in FIG. 7, but with an added layer of MgSO₄ or MgO sandwiched between the 2^{nd} composite containment vessel and an added 3^{rd} composite containment vessel;

FIG. 9 depicts the current flow through the CNT's depicted in FIG. 7 and FIG. 8.

### DESCRIPTION OF THE PREFERRED EMBODIMENTS

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

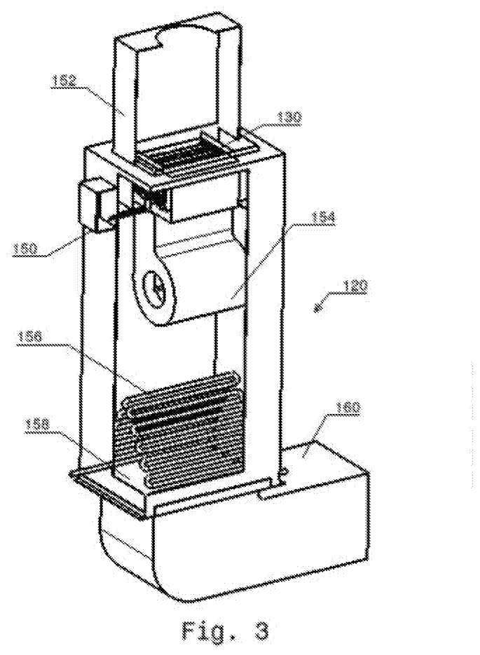

FIG. 3 depicts an air-handler unit 120 installed in a residence, modified to include a 3D CNT heating assembly 130 in an upper portion of the air-handler, according to the inventive principles. The inventive air handler also includes and electrical controller panel 150, a plenum 152 from which air warmed or heated from the 3D CNT heating assembly 130 is delivered to an interior of the residence. A lower or second compartment with a blower 154, an A-frame/evaporator coil 156, an air-filter 158 and return air-duct 160 through which interior room air passes for heating/conditioning. As shown, the first and second compartments are vertically aligned (can be horizontally aligned) to provide compactness.

The return air duct directs non-conditioned ambient temperature air through the air-filter from the interior of the house, initiated from the blower, which pulls filtered air through the A-frame/evaporator coil and pushes it through the 3D CNT heating assembly thus forcing the conditioned and heated air into the plenum and from there, through the entire interior residential space. That is, air from the lower/2^{nd} compartment passes through the upper/1^{st} compartment 3D CNT heating assembly 130, is heated therein and dispersed to its final destination. This simple design, and steps for heating and delivering air in reliance upon the inventive structural arrangement, eliminate the need to use a more costly refrigeration cycle to move heat energy from a first environment (exterior) to a second environment (interior), i.e., a heat pump.

Such an inventive system also eliminates a need to supplement the heat pump therein with emergency heat strips, thus lowering the manufacturing costs, operating costs, maintenance costs and need for added equipment costs such as humidifiers. In the case where a retrofit would be more practical, energy reduction is achieved according to the invention by simply removing the existing emergency heating strips (as the case may be) and disabling the reversing valve in the heating portion of the conventional heat pump and inserting an inventive 3D CNT Heating assembly, such as heating assembly 130 into the cavity vacated by the Emergency Heating Strips. In the retrofit, the existing wiring and control panel may be utilized without concern for current overload as the 3D CNT heating assembly uses 72% less current than the emergency heating strips. This reduction along with an added 72% reduction in energy consumption from the Heat Pump delivers a substantial reduction in energy consumption.

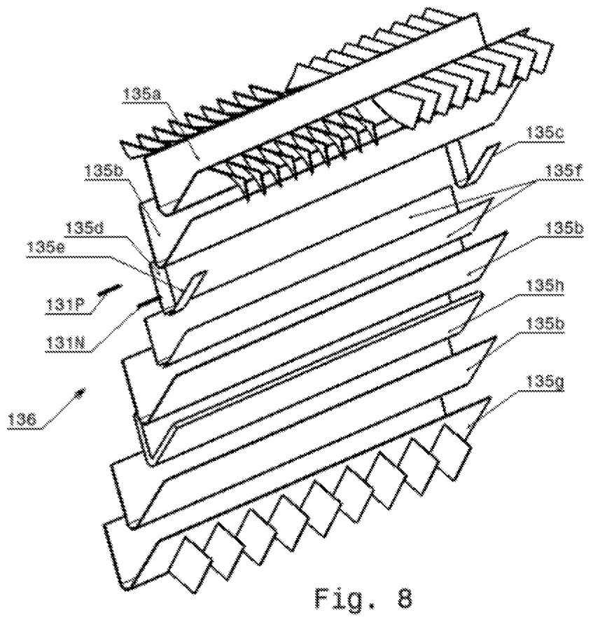

It should be noted that these improvements were achieved without the added layer of MgSO₄ or MgO to the 3D CNT heating assembly, such as in the alternative embodiment heating assembly depicted in FIG. 8. As described in greater detail below, the FIG. 8 heating assembly relies upon MgSO₄, which has a heat storage density (GJ/m³) of 2.6 times the existing CNT heat assembly output. Likewise, MgO has a heat storage density of 3.4 times the existing CNT heat assembly output, thus increasing the energy efficiency beyond what is currently stated and tested.

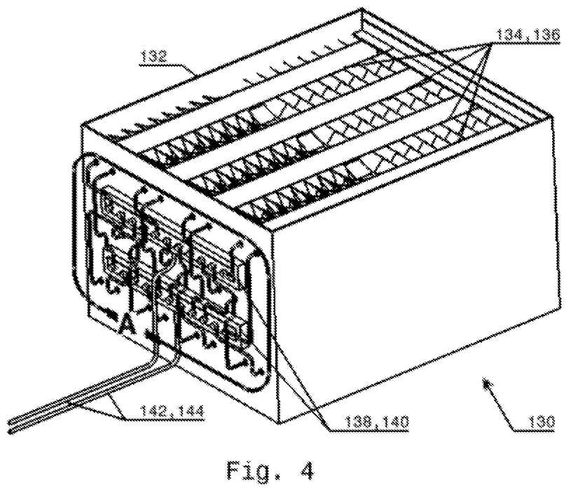

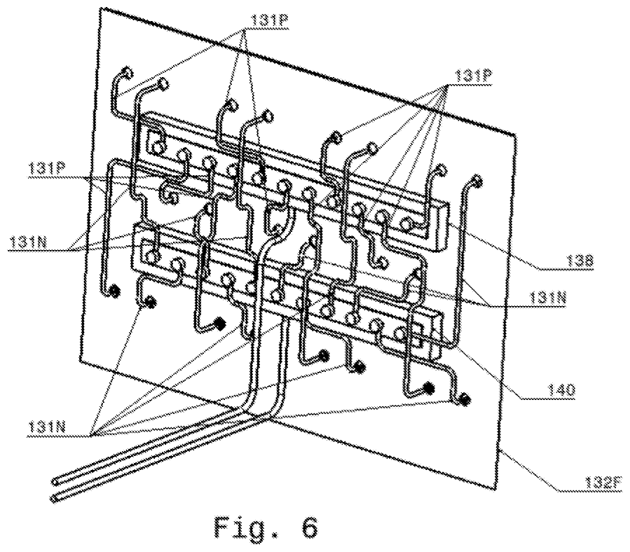

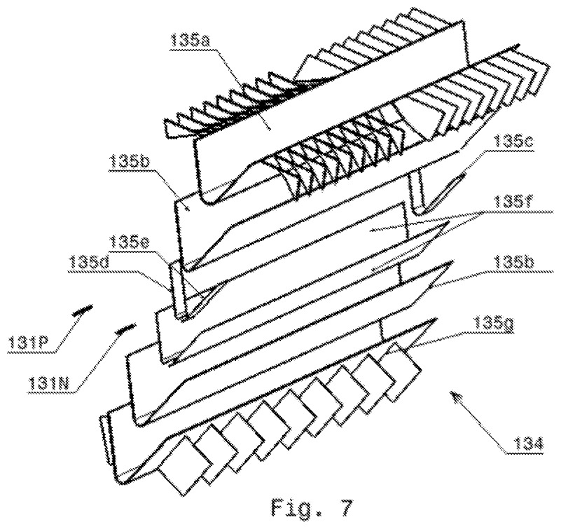

The CNT heating assembly 130 is depicted in detail in FIG. 4. As shown, the CNT heating assembly 130 includes a metal housing 132, which is typically bent sheet metal formed. Contained within that housing 132 is a series of 3D CNT graphene heating elements 134, 136 (see FIGS. 7 and 8). The CNT heating assembly 130 also includes a positive (+) terminal block assembly 138 and negative (−) terminal block assembly 140. Connecting the 3D CNT heating assembly 130 to the control panel relies upon 8-gage connector wires 142, 144 Wire 142 is connected to the positive (+) terminal block assembly 138 and wire 144 is shown connected to negative (−) terminal block assembly 140. The 3D CNT graphene heating elements 134, 136 are connected to the positive and negative terminal block assemblies by the copper wires 131P, 131N (see FIG. 6).

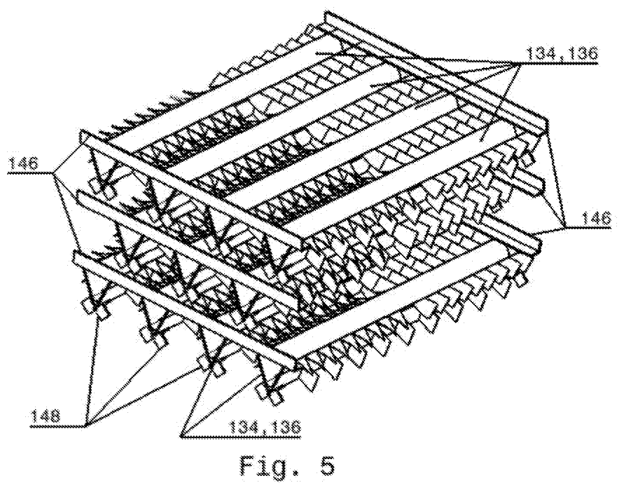

FIG. 5 depicts the FIG. 4 CNT heating assembly 130 with the sheet metal housing 132 and terminal block assemblies 138, 140 and wiring diagrams removed for clarity. Also shown are the upper attach brackets 146, attach brackets 148 and 3 rows of 3D CNT graphene heating elements 134, 136. The attach brackets 148 are fastened (fasteners not shown) to each end of the sheet metal housing 132 (not shown for clarity), creating a cradle for the 3D CNT graphene heating elements 134, 136. 3D CNT graphene heating elements 134, 136 are dropped onto the attach brackets 148, and the upper attach brackets 146 are then placed over the 3D CNT graphene heating elements 134, 136, thus locking them into place.

FIG. 6 shows a forward face 132F of the sheet metal housing 132, highlighting the wiring diagram of the 3D CNT heating assembly 130. As shown, copper wires 131P are routed and attached to a positive terminal block assembly 138. Copper wires 131N are routed to the negative terminal block assembly 140.

FIG. 7 highlights the 3D CNT graphene heating elements 134. CNT graphene heating elements 134 comprise an upper metallic heat dispersion vein/radiator 135a, and two (2) composite containment vessels 135b, which are made from a high temperature resistant, electrically non-conductive, and highly conductive heat transfer prepreg. Also, a copper bus turnaround 135c, one (1) copper bus (wire) 135d and one (1) copper bus (wire) 135e, two (2) 3D CNT graphene films 135f, a lower metallic heat dispersing vein/radiator 135g and one (1) terminal (+) 131P and one (1) terminal (−) 131N, are included.

FIG. 8 depicts 3D CNT graphene heating elements 136, which comprise an upper metallic heat dispersion vein/radiator 135a, three (3) composite containment vessels 135b (made from a high temperature resistant, electrically non-conductive, and highly conductive heat transfer prepreg), a copper bus turnaround 135c, a positive 135d and a negative 135e copper bus, two (2) 3D CNT graphene films 135f, a lower metallic heat dispersing vein/radiator 135g, a positive 131P and a negative 131N copper wire, and an added layer of MgSO₄ or MgO 135h. The FIG. 8 heating elements 136 are similar to the heating elements 134 of FIG. 7 with the addition of either MgSO₄ or MgO 135h after the 2^{nd} layer of composite containment vessel 135b sandwiched between a 3^{rd} layer of composite containment vessel 135b and finally closed out by the lower metallic heat dispersing vein/radiator 135g. The added benefit of the MgSO₄ or MgO 135h is to increase the efficiency of the 3D CNT heating assemblies 130 by 2.6 to 3.4 times

The embodiment depicted in FIG. 8 work similarly to the embodiment of FIG. 7, where the added layer of MgSO₄ 135h FIG. 8 or MgO 135h FIG. 8 only reacts to the heating of the 3D CNT graphene films 135f. In the case where the layer comprises MgSO₄, 135h, when the 3D CNT graphene films 135f are heated with sufficient energy to reach 125° C., the MgSO₄ layer leverages the applied energy and thereby magnifies the resulting heat energy 2.6 times, i.e., approximating 325° C.; in the case where the strip or coating comprises MgO 135h, if the 3D CNT graphene films 135f are driven by electrical energy that would normally result in heating to 350° C., the MgO layer 135h operates to leverage and magnify the applied energy 3.4 times, approximating 1190° c.

Leveraging the MgSO₄ 135h would take the efficiency savings from 72% to 89% compared to a standard heat pump. Table I below is a comparison of heat storage methods and materials that are relevant to the invention.

The assembly process of the CNT graphene heating element 134 (FIG. 7) is quite simple, yet critical to ensure robust longevity of the assembly. The first step is to braze the positive and negative copper wires 131P, 131N to the positive and negative copper bus 135d, 135e. The next operations must be executed in a clean room. First, a sheet of composite prepreg 135b is arranged in a 2D format, after the two 3D CNT graphene film strips 135f are placed onto the composite prepreg 135b. This process can be automated for accuracy and cost reduction. Next, the copper bus turnaround 135c is positioned at one end over the 3D CNT graphene film strips 135f. At the opposite end, the positive and negative copper busses 135d, 135e, with copper wire pre-brazed 131P, 131N is placed over the 3D CNT graphene film strips 135f. The positive 135d and negative 135e busses should not make contact. Next, a layer of composite prepreg 135b is placed over the 3D CNT graphene film 135f and copper busses 135c, 135d, 135e, ensuring no contaminants have been introduced and thus completing the circuit.

This sub-assembly is next placed between metallic mandrels and cooked per the composite manufacturer's requirements. Once cooked, the sub-assembly is hermitically sealed. As such, along with ensuring no contaminates have been introduced, the heating element assemblies are expected to have very long life cycles. The final step is to sandwich the composite prepreg sub-assembly between the upper metallic heat dispersion vein/radiator 135a and the lower metallic heat dispersion vein/radiator 135g completing the 3D CNT graphene heating element 134. Once complete, the assembly process can be executed per instructions provided in FIGS. 4-6.

The process of forming the graphene heating element 136 is substantially similar to that of graphene heating element 134, except for the additional step or act of adding a layer of MgSO₄ or MgO 135h, followed by another layer of composite prepreg 135b, as described in FIG. 8. The assembly is then cooked between metallic mandrels similar to graphene heating element 134, prior to final assembly between the upper metallic heat dispersion vein/radiator 135a and the lower metallic heat dispersion vein/radiator 135g.

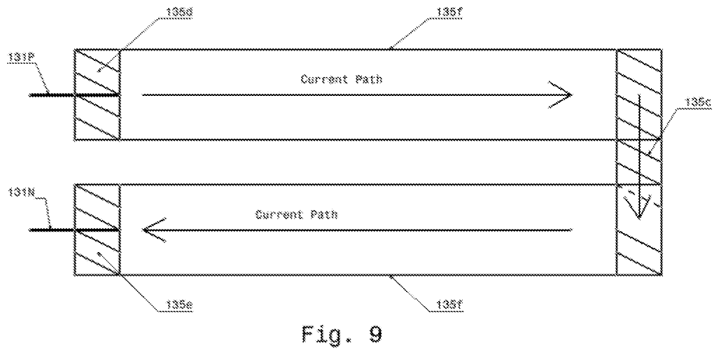

FIG. 9 depicts the current flow through the 3D CNT graphene films 135f. As shown therein, the strips of 3D CNT graphene film 135f aligned parallel to each other with a space shown between them. At one end of the 3D CNT graphene film 135f is a copper bus 135c which connects the upper 3D CNT graphene film 135f and lower 3D CNT graphene film 135f strips (shown at right of figure). At the left side, two shorter sections of copper bus 135d & 135e are arranged as terminals. The copper wire 131P & 131N brazed to the two-separate bus's (terminals), as shown. When a voltage is applied, a current will flow along the path as shown. This current will transfer from the copper bus 135d to the CNT film 135f and cause the 3D CNT graphene film 135f to efficiently produce heat. The current will flow in the direction shown (left to right) and use the turnaround bus 135c to cross over and activate the 3D CNT graphene film 135f (parallel strip), achieving the same result as the first 3D CNT graphene film 135f the circuit is now complete. The designations positive or negative are for readability only. There are positive or negative bus's per se. The only real requirements is that the wires are not crossed when connecting multiple elements together. The electrical current required to power the 3D CNT Film is taken from the formula V=I*R or V/R=I where V is determined by current input.

Resistance (R) of 3D CNT film: determined by l/w where l=length and w=width Example: a sheet of 3D CNT film is 10″×1″;

R=10/1=10 and Predicted Temp C°@100V=(Ai*IP₁)+IP₂

100V/10R=I or I=10

Predicted Temp C°=(Ai*IP₁)+IP₂=((10/1)*IP₁)+IP_{z}=IP₃ C°

In conclusion the 3D CNT graphene film 135f can be configured to control the exact Volts and Amps desired to achieve a specific temperature. A controller would be configured that would regulate/deliver this exact amount of Voltage and Amperage. In this example it would be 100V and 10 amps or 1000 watts.

The person of ordinary skill in the art should recognize that if a 2^{nd} layer of 3D CNT graphene film 135f were laid out in parallel with a sheet of composite containment vessel 135b between/separating the layers of 3D CNT graphene film the configuration would now change to length/width as 10/2. As should be clear, the length is not affected because the 3D CNT graphene film is connected together by an equal set of copper wires and busses. Only the width is impacted, which would lower the resistance to 10/2 or 5. The same formula would apply but with a different resistance and a different value for Ai, thus changing the results. In the case of the prototype described, applicants have 11 sets of 134, 136 assemblies, which would change w (width) by 11 times, l (length) would remain the same. Ultimately the possibilities are infinite depending on the desired result.

While the exemplary embodiment of the CNT heating elements reflect an upper metallic heat dispersion vein/radiator, a first composite containment vessel, a first layer of 3D CNT graphene film consisting of 2 separate strips of 3D CNT graphene films, a second composite containment vessel; and a lower metallic heat dispersing vein/radiator, the invention is not limited thereto. Any number of CNT heating elements may further comprise additional composite containment vessel and respective layers of MgSO4 or MgO is arranged above and/or below the additional composite containment vessels. Preferably, the first and second composite containment vessels are formed from high-temperature resistant, electrically non-conductive, and highly heat conductive prepregs.

Retrofit

In the common occurrence where an existing residential heating system is well within the life cycle of the heating assembly therein, the inventive heating assembly 130 may easily be retrofitted into the current system, implementing savings over the existing system. The first step is to remove the current standard resistance heater coils also known as “strip heaters.” In place thereof, the 3D CNT heating assembly 130 is arranged in the cavity vacated by the standard resistance heater coils. If the 3D CNT heating assembly 130 does not fit into the existing vacant cavity, a sheet metal transition plenum can be fabricated by the installer and attached to the air handler assembly shown in FIG. 3. This will fit in front of the vacated cavity under the air handler plenum 152.

Next the reversing valve in the heating portion of the heat pump is deactivated, and the 3D CNT heating assembly 130 is connected to the controller panel on the air handler assembly (FIG. 3). Because the 3D CNT heating assembly 130 uses approximately 72% less current than the existing/removed “heat strips,” the 3D CNT heating assembly 130 is fully within the limits of the controller panel capabilities. An added benefit is the 3D CNT heating assembly 130 also uses approximately 72% less energy than the disabled Heat Pump thus compounding the energy savings.

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A thermo-electric heating assembly for forced air, residential and commercial heating, ventilation and air conditioning (HVAC) systems, the heating assembly comprising:
a housing;
a controller; and
a plurality of carbon nanotube (CNT) heating elements, arranged in the housing;
wherein, the controller is adapted to respond to a signal received by the controller indicating a need for heat by powering the carbon nanotube (CNT) heating elements at a controlled electrical power level for a controlled period, commensurate with the indicated need for heat and commensurate with an increased energy efficiency of the CNT heating elements.

2. The thermo-electric heating assembly of claim 1, wherein each of the plurality of CNT heating elements comprises:
an upper metallic heat dispersion vein/radiator;
a first composite containment vessel;
3D CNT graphene arranged in two separate 3D CNT graphene films;
a second composite containment vessel; and
a lower metallic heat dispersing vein/radiator.

3. The thermo-electric heating assembly of claim 2, wherein one of the 3D CNT graphene films is arranged on a surface of the first composite containment vessel and another of the 3D CNT graphene films is arranged on either an opposing surface of the first composite containment vessel or a surface of the second composite containment vessel.

4. The thermo-electric heating assembly of claim 2, wherein the CNT heating elements further comprising a third composite containment vessel and a layer of MgSO₄ or MgO is arranged between the third composite containment vessel and the lower metallic heat dispersing vein/radiator.

5. The thermo-electric heating assembly of claim 2, wherein the first and second composite containment vessels are formed from high-temperature resistant, electrically non-conductive, and highly heat conductive prepregs.

6. An assemblage of elements arranged in a kit for replacing a heating assembly positioned in a plenum, or proximate a plenum, of a forced air, residential and commercial heating, ventilation and air conditioning (HVAC) system, the kit comprising:
a thermo-electric heating assembly; and
wires, connected at one end to the thermo-electric heating assembly, for connecting at another end to a control panel of the HVAC system;
wherein, the thermo-electric heating assembly comprises:
a housing;
a controller; and
a plurality of carbon nanotube (CNT) heating elements, arranged in the housing;
wherein, the controller is adapted to respond to a signal received by the controller indicating a need for heat by powering the carbon nanotube (CNT) heating elements at a controlled electrical power level for a controlled period, commensurate with the indicated need for heat and commensurate with an increased energy efficiency of the CNT heating elements.

7. A forced air, residential and commercial heating, ventilation and air conditioning (HVAC) system, comprising:
a plenum;
an air handler;
a controller; and
a thermo-electric heating assembly, the heating assembly comprising:
a housing; and
a plurality of carbon nanotube (CNT) heating elements, arranged in the housing;
wherein, the controller is adapted to respond to a signal received by the controller indicating a need for heat by powering the carbon nanotube (CNT) heating elements at a controlled electrical power level for a controlled period, commensurate with the indicated need for heat and commensurate with an increased energy efficiency of the CNT heating elements.

8. The forced air, residential and commercial heating, ventilation and air conditioning (HVAC) system of claim 7,
wherein the CNT heating elements further comprise a third composite containment vessel and a layer of MgSO₄ or MgO is arranged between the third composite containment vessel and the lower metallic heat dispersing vein/radiator.

9. The forced air, residential and commercial heating, ventilation and air conditioning (HVAC) system of claim 7,
wherein, each of the plurality of CNT heating elements comprises a first composite containment vessel, a first layer of 3D CNT graphene film consisting of 2 strips of 3D CNT graphene film, a second composite containment vessel.

10. The forced air, residential and commercial heating, ventilation and air conditioning (HVAC) system of claim 7,
wherein the CNT heating elements further comprise additional composite containment vessels, and associated layers of MgSO₄ or MgO respectively arranged under each of the additional composite containment vessels.
